(19) United States
(12) Patent Application Publication
(10) Pub. No.: US 2026/0270774 A1
(43) Pub. Date: Sep. 10, 2026

(54) INFORMATION PROCESSING APPARATUS AND METHOD AND COMMUNICATION SYSTEM

(71) Applicant: 1FINITY Inc., Kawasaki-shi (JP)

(72) Inventors: Guorong LI, Beijing (CN); Meiyi JIA, Beijing (CN); Su YI, Beijing (CN); Xin WANG, Beijing (CN)

(73) Assignee: 1FINITY Inc., Kawasaki-shi (JP)

(21) Appl. No.: 19/662,196

(22) Filed: Apr. 29, 2026

Related U.S. Application Data
(63) Continuation of application No. PCT/CN2023/128902, filed on Oct. 31, 2023.

(51) Int. Cl. H04W 28/02

(52) U.S. Cl. CPC H04W 28/0278

(57) ABSTRACT

An information processing apparatus and method and a communication system. The information processing method includes: determining that a minimum remaining time of uplink buffer data in logical channel groups is lower than a first threshold and there is no pending delay status report associated with the logical channel groups; and triggering a delay status report for the logical channel groups.

### CROSS-REFERENCE TO RELATED APPLICATION

This application is a continuation application under 35 U.S.C. 111 (a) of International Patent Application PCT/CN2023/128902 filed on Oct. 31, 2023, and designated the U.S., the entire contents of which are incorporated herein by reference.

### FIELD

This disclosure relates to the field of communication technologies.

### BACKGROUND

In the 3rd Generation Partnership Project (3GPP), study of enhancement of extended reality (XR) services began in Release 18. XR services refer to environments of all real and virtual combinations and human-computer interaction generated by computer technologies and wearable devices. XR services may include virtual reality (VR) services, augmented reality (AR) services and mixed reality (MR) services.

For XR services with strict delay restrictions, a scheduler with delay information is beneficial to meet the quality of service (QoS). The scheduler with delay information may be implemented in downlink, because a network side (such as a gNB) learns QoS characteristics of a user equipment (such as learning via a 5G quality of service parameter, such as a 5G QoS identifier (5QI)), and also learns when XR frames (packets) arrive, hence, it also learns a degree of urgency of scheduling buffered data.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

It was found by the inventors that for uplink, as a current buffer status report (BSR) only provides a size of buffered data, but does not transfer information on how long the data in a user equipment (UE) has been buffered, a scheduler at a network side is unable to accurately learn a buffered time of the data in the UE, hence, it is deemed in 3GPP that reporting delay information by the UE is beneficial to XR services.

Currently, it has been agreed in 3GPP to introduce reporting of delay information. For example, for XR services, data volume information associated with delay information (e.g. a remaining time) is introduced, and an MAC CE in a new form is adopted to report a delay status report (DSR), the DSR MAC CE including a remaining time and its associated data volume information. However, conditions for triggering the DSR have not yet been clarified.

In order to solve at least one of the above problems, embodiments of this disclosure provide an information processing apparatus and method and a communication system.

According to one aspect of the embodiments of this disclosure, there is provided an information processing method, applicable to a terminal equipment, the method including: determining that a minimum remaining time of uplink buffer data in/of/for logical channel groups is lower than a first threshold and there is no pending delay status report associated with the logical channel groups; and triggering a delay status report for the logical channel groups.

According to another aspect of the embodiments of this disclosure, there is provided an information processing method, applicable to a network device, the method including: receiving a delay status report transmitted by a terminal equipment, wherein the delay status report corresponds to logical channel groups, and a minimum remaining time of uplink buffer data in the logical channel groups is lower than a first threshold.

According to a further aspect of the embodiments of this disclosure, there is provided an information processing apparatus, configured in a terminal equipment, the apparatus including: a first determining unit configured to determine that a minimum remaining time of uplink buffer data in logical channel groups is lower than a first threshold and there is no pending delay status report associated with the logical channel groups; and a first processing unit configured to trigger a delay status report for the logical channel groups.

According to still another aspect of the embodiments of this disclosure, there is provided an information processing apparatus, configured in a network device, the apparatus including: a first receiving unit configured to receive a delay status report transmitted by a terminal equipment, wherein the delay status report corresponds to logical channel groups, and a minimum remaining time of uplink buffer data in the logical channel groups is lower than a first threshold.

According to yet another aspect of the embodiments of this disclosure, there is provided a communication system, including a terminal equipment configured to determine that a minimum remaining time of uplink buffer data in logical channel groups is lower than a first threshold and there is no pending delay status report associated with the logical channel groups, and trigger a delay status report for the logical channel groups, and a network device configured to receive the delay status report.

One of the advantages of the embodiments of this disclosure exists in that conditions for triggering the delay status report are clarified, which may reasonably trigger the delay status report, avoid unnecessarily triggering or transmitting the delay status report, and is advantageous to radio resource saving and transmit power of the terminal equipment.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of an embodiment of this disclosure;

FIGS. 2-5 are schematic diagrams of an information processing method of an embodiment of this disclosure;

FIGS. 6-9 are schematic diagrams of an information processing apparatus of an embodiment of this disclosure;

FIG. 10 is a schematic diagram of a network device of an embodiment of this disclosure; and

FIG. 11 is a schematic diagram of a terminal equipment of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any level, which may, for example, include but not limited to the following communication protocols: 1G (generation), 2G, 2.5G, 2.75G, 3G, 4G, 4.5G, 5G, New Radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, a machine to machine (M2M) terminal, and a terminal supporting sidelink communication, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. Uplink signals may include uplink data signals and/or uplink control signals, and may also be referred to as uplink transmissions (UL transmissions) or uplink information or uplink channels. Transmitting uplink transmission on an uplink resource may be understood as transmitting the uplink transmission by using the uplink resource. Likewise, downlink data/signals/channels/information may be understood accordingly.

In the embodiments of this disclosure, high layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

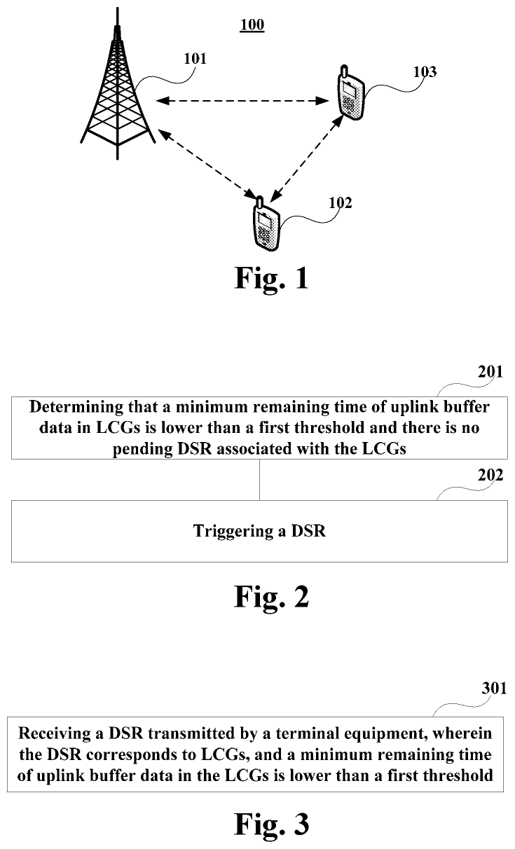

FIG. 1 is a schematic diagram of a communication system of an embodiment of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiment of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

Wherein, the terminal equipment 102 may transmit data to the network device 101, such as in a dynamically-scheduled granted or configured granted manner. The network device 101 may receive data transmitted by one or more terminal equipments 102, and transmit information scheduling uplink new data transmission or uplink data retransmission to the terminal equipment 102, or may transmit downlink data.

The information processing method and apparatus of the embodiments of this disclosure shall be described below with reference to the accompanying drawings.

### Embodiment of a First Aspect

The embodiment of this disclosure provides an information processing method, applicable to a terminal equipment (UE) side, which shall be described below with reference to the accompanying drawings.

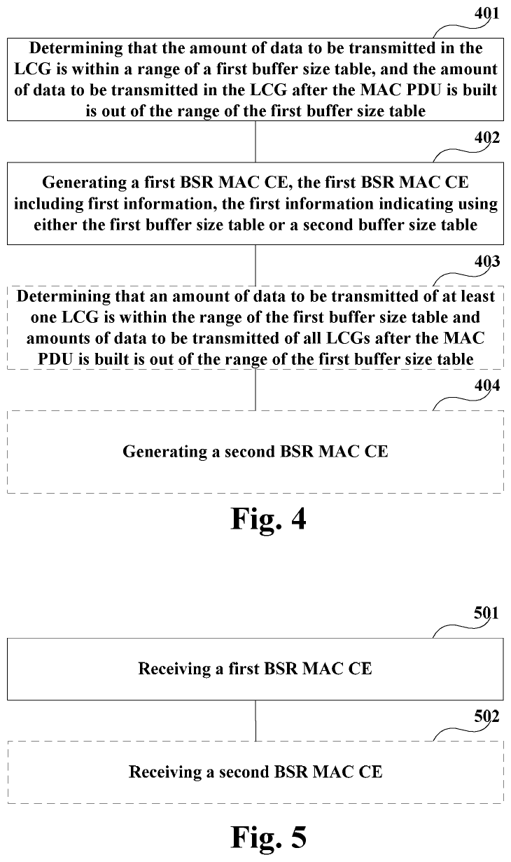

FIG. 2 is a schematic diagram of the information processing method of the embodiment of this disclosure. As shown in FIG. 2, the method includes:
201: determining that a minimum remaining time of uplink buffer data in logical channel groups (LCGs) is lower than a first threshold and there is no pending delay status report (DSR) associated with the LCGs; and
202: triggering a delay status report.

According to the above embodiment, conditions for triggering the DSR are clarified, which may reasonably trigger the DSR, avoid unnecessarily triggering or transmitting the DSR, and is advantageous to radio resource saving and transmit power of the terminal equipment.

In some embodiments, if a minimum remaining time of uplink buffer data in an LCG in at least one LCG configured for the UE is below a first threshold and there is no pending DSR associated with the LCG, the DSR is triggered.

In some embodiments, the remaining time of the uplink buffer data may be calculated based on a value of a PDCP (packet data convergence protocol) discard timer (e.g. PDCP discardTimer).

For example, for a PDCP layer of the UE, a PDCP entity may calculate a remaining time of a packet data convergence protocol service data unit (PDCP SDU) for the PDCP layer based on a value of a discard timer (discardTimer) with which the PDCP SDU is associated. For example, when the PDCP layer of the UE receives a PDCP SDU from an upper layer (such as an application layer, etc.), if discardTimer to/with which the PDCP SDU corresponds/is associated is configured, discardTimer is started. The remaining time of the PDCP SDU is calculated according to a value of discardTimer, for example, the remaining time may be a remaining time to expiry of discardTimer.

In addition, for an RLC (radio link control) layer of the UE, an RLC entity may calculate a remaining time of a radio link control service data unit (RLC SDU) for the RLC layer based on a value of a discard timer (discardTimer) with which the RLC SDU is associated. For example, when the RLC layer of the UE receives an RLC SDU from an upper layer (such as a PDCP layer, etc.), the upper layer may notify a value of discardTimer with which the RLC SDU is associated, and the RLC layer of the UE calculates a remaining time of the RLC SDU according to the value of discardTimer, for example, the remaining time may be a remaining time to expiry of discardTimer, wherein the value of discardTimer with which the RLC SDU is associated may be determined according to a value of discardTimer associated with a PDCP SDU to which the RLC SDU corresponds.

In some embodiments, when discardTimer associated with a PDCP SDU expires, the PDCP entity of the UE discards the PDCP SDU and a PDCP data PDU (packet data convergence protocol data unit) containing the PDCP SDU. If a corresponding PDCP data PDU has already been submitted to a lower layer (such as an RLC layer), the discarding is indicated to the lower layer.

For the RLC layer of the UE, when a specific RLC SDU is indicated to be discarded from an upper layer (such as a PDCP layer, etc.), if the RLC SDU or the RLC SDU segment has not been submitted to a lower layer (such as an MAC layer, etc.), the RLC entity discards the indicated RLC SDU.

In some embodiments, discardTimer may be configured by the network side, such as being configured by the network based on a DRB (data radio bearer) of the UE. An initial or maximum value of discardTimer may be configured by the network side, wherein the initial value may be set to be an integer greater than 0, and a value of discardTimer when it is started is set to be the initial value configured by the network. The value of discardTimer decreases over time after it is started, and when the value decreases to 0, it is deemed that discardTimer expires. Or, when the initial value of the discardTimer when it is started is set to be 0, discardTimer increases over time after it is started, and when it reaches a maximum value configured by the network, it is deemed that discardTimer expires.

In some embodiments, ‘if a minimum remaining time of uplink buffer data in an LCG is below a first threshold’ may also be expressed as: if a minimum value of remaining times till expiry of PDCP discard timers of all uplink buffer data in an LCG is below a first threshold, ‘there is no pending DSR associated with the LCG’ may also be expressed as: the LCG has not triggered a DSR since last transmission of a DSR MAC CE, and ‘triggering a DSR’ may also be expressed as: triggering a DSR of the LCG, that is, in a case where more than one LCG satisfies the above conditions, associated DSRs of the LCGs are respectively triggered.

In some embodiments, each LCG may be configured with a first threshold, the first threshold being configured by the network device.

In some embodiments, a minimum remaining time of uplink buffer data in an LCG may be explicitly included in a DSR.

In some embodiments, the DSR may be triggered by the MAC entity of the UE. For example, the PDCP entity and/or the RLC entity of the UE indicate(s) the remaining time of the uplink buffer data to the MAC entity of the UE, and the MAC entity triggers the DSR according to the remaining time and the first threshold.

In some embodiments, the remaining time indicated by the PDCP entity and/or the RLC entity may include a remaining time to the expiry of the discard timer or a remaining value of the discard timer.

In some embodiments, the PDCP entity and/or RLC entity of the UE may also indicate an amount of data of the uplink buffer data to the MAC entity.

For example, the PDCP entity and/or the RLC entity of the UE may indicate the minimum remaining time and the amount of data of the uplink buffer data associated therewith to the MAC entity of the UE; or, the PDCP entity and/or the RLC entity of the UE may also indicate remaining times of all uplink buffer data in the LCG and amounts of data of uplink buffer data associated therewith to the MAC entity of the UE.

In some embodiments, the uplink buffer data include first data in the buffer that are not successfully transmitted, that is, the minimum remaining time of the uplink buffer data refers to a minimum remaining time of the first data in the buffer that are not successfully transmitted. Hence, accuracy and reliability of the minimum remaining time may be improved, which may further avoid unnecessarily triggering or transmitting the DSR, and is beneficial for saving uplink radio resources and transmit power of the terminal equipment.

For example, there may exist following data (i.e. second data) in the buffer: data that have been successfully transmitted but are still in the buffer. If uplink buffer data with a minimum remaining time or uplink buffer data with a shortest remaining time to the expiry of the PDCP discardTimer are the second data, triggering the DSR for the second data will cause waste of radio resources and transmit power of the UE.

In determining the minimum remaining time of uplink buffer data, the second data that have been successfully transmitted but are still in the buffer are excluded, or the first data in the buffer that have not been successfully transmitted are only taken into account. Hence, triggering or reporting the DSR for the second data may be avoided, which is beneficial for saving uplink radio resources and transmit power of the terminal equipment.

In some embodiments, the first data may include at least one of the following: a PDCP SDU, a PDCP data PDU, an RLC SDU, an RLC SDU segment, or an RLC data PDU.

In some embodiments, the uplink buffer data (e.g. the first data) may include at least one of the following:
a PDCP SDU that has not yet been built to a PDCP data PDU;
a PDCP data PDU that has not yet been submitted to a lower layer;
a PDCP SDU to be retransmitted for a radio data bearer in an acknowledgement mode;
a PDCP data PDU to be retransmitted for a radio data bearer in the acknowledgement mode;
a PDCP SDU that belongs to a delay sensitive protocol data unit (PDU) set and has not yet been built to a PDCP data PDU;
a PDCP data PDU that contains a PDCP SDU belonging to the delay sensitive PDU set and has not yet been submitted to the lower layer;
a delay sensitive PDCP SDU that has not yet been built to a PDCP data PDU;
a PDCP data PDU that contains a delay sensitive PDCP SDU and has not yet been submitted to a lower layer;
an RLC SDU or an RLC SDU segment that has not yet been included in an RLC data PDU;
an RLC data PDU pending for initial transmission;
an RLC data PDU pending for retransmission;
an RLC SDU or an RLC SDU segment that has not yet been included in an RLC data PDU and belongs to the delay sensitive PDU set;
an RLC data PDU that contains an RLC SDU or an RLC SDU segment belonging to a delay sensitive PDU set and is pending for initial transmission or retransmission;
a delay sensitive RLC SDU or RLC SDU segment that has not yet been included in an RLC data PDU; or
an RLC data PDU that contains a delay sensitive RLC SDU or RLC SDU segment and is pending for initial transmission or retransmission.

In some embodiments, at the PDCP layer, the PCDP entity assembles a PDCP SDU issued by an upper layer (e.g. an application layer) into a PDCP data PDU. At the RLC layer, the RLC entity assembles an RLC SDU issued by the upper layer (e.g. a PDCP layer) into an RLC data PDU, or segments the RLC SDU, and assembles RLC SDU segments into an RLC data PDU.

In some embodiments, the lower layer includes, for example, an RLC layer.

In some embodiments, the delay sensitive PDCP SDU may include a PDCP SDU with a remaining time to expiry of the discard timer less than a second threshold.

The second threshold may be identical to the first threshold. However, this disclosure is not limited thereto, and the second threshold may also be a threshold determined according to the first threshold, such as adding or subtracting an offset to or from the first threshold, or, the second threshold is a threshold configured by the network device.

In some embodiments, the delay sensitive PDU set may be a set to which the delay sensitive PDCP SDU belongs.

In some embodiments, the delay sensitive RLC SDU may include an RLC SDU with a remaining time till expiry of the discard timer less than a third threshold.

The third threshold may be identical to the first threshold or the second threshold. However, this disclosure is not limited thereto, and the third threshold may also be a threshold determined according to the first threshold or the second threshold, such as adding or subtracting an offset to or from the first threshold or the second threshold, or, the third threshold is a threshold configured by the network device.

In some embodiments, the delay sensitive PDU set may be a set to which the delay sensitive RLC SDU belongs.

In some embodiments, the second data that have been successfully transmitted but are still in the buffer may include at least one of the following: a PDCP SDU, a PDCP data PDU, an RLC SDU, an RLC SDU segment, or an RLC data PDU.

In some embodiments, the uplink buffer data do not include the following data (i.e. the second data) that: RLC acknowledgement (RLC ACK) for the data is received, and a discard timer associated with the data has not expired; or, RLC acknowledgement for the data is received, and successful transmission of the data has not been acknowledged by a PDCP status report.

In some embodiments, the UE may transmit the triggered DSR, wherein the UE may report the DSR via various signaling. For example, the UE may define a separate MAC CE for reporting the DSR. However, this disclosure is not limited thereto, and the DSR may also be carried by other existing signaling (such as RRC signaling, etc.), or may be carried by an existing MAC CE. However, this disclosure is not limited thereto, and the UE may also cancel the triggered DSR.

It should be noted that FIG. 2 only schematically illustrates the embodiment of this disclosure; however, this disclosure is not limited thereto. For example, an order of execution of the operations may be appropriately adjusted, and furthermore, some other operations may be added, or some operations therein may be reduced, and objects of the above operations may also be adjusted. And appropriate variants may be made by those skilled in the art according to the above contents, without being limited to what is contained in FIG. 2.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where the minimum remaining time of the uplink buffer data in the logical channel groups is lower than the first threshold and there is no pending delay status report associated with the logical channel groups, the terminal equipment triggers the delay status report for the logical channel groups. Hence, conditions for triggering the delay status report are clarified, which may reasonably trigger the delay status report, avoid unnecessarily triggering or transmitting the delay status report, and is advantageous to radio resource saving and transmit power of the terminal equipment.

### Embodiment of a Second Aspect

The embodiment of this disclosure provides an information processing method, applicable to a network device. Reference may be made to the embodiment of the first aspect for contents identical to those in the embodiment of the first aspect, which shall not be repeated herein any further.

FIG. 3 is a schematic diagram of the information processing method of the embodiment of this disclosure, applicable to a network device. As shown in FIG. 3, the method includes:
301: receiving a delay status report (DSR) transmitted by a terminal equipment, wherein the DSR corresponds to logical channel groups (LCGs), and a minimum remaining time of uplink buffer data in the LCGs is lower than a first threshold.

In some embodiments, there is no pending DSR associated with the LCGs before the DSR is triggered by the terminal equipment.

In some embodiments, after receiving the DSR, the network device allocates uplink resources to the terminal equipment according to the DSR.

In some embodiments, the uplink buffer data include first data in the uplink buffer that have not been successfully transmitted.

In some embodiments, the first data include at least one of a PDCP SDU, a PDCP data PDU, an RLC SDU, an RLC SDU segment, or an RLC data PDU.

In some embodiments, the uplink buffer data include at least one of the following:
a PDCP SDU that has not yet been built to a PDCP data PDU;
a PDCP data PDU that has not yet been submitted to a lower layer;
a PDCP SDU to be retransmitted for a radio data bearer in an acknowledgement mode;
a PDCP data PDU to be retransmitted for a radio data bearer in the acknowledgement mode;
a PDCP SDU that belongs to a delay sensitive protocol data unit (PDU) set and has not yet been built to a PDCP data PDU;
a PDCP data PDU that contains a PDCP SDU belonging to the delay sensitive PDU set and has not yet been submitted to the lower layer;
a delay sensitive PDCP SDU that has not yet been built to a PDCP data PDU;
a PDCP data PDU that contains a delay sensitive PDCP SDU and has not yet been submitted to a lower layer;
an RLC SDU or an RLC SDU segment that has not yet been included in an RLC data PDU;
an RLC data PDU pending for initial transmission;
an RLC data PDU pending for retransmission;
an RLC SDU or an RLC SDU segment that has not yet been included in an RLC data PDU and belongs to the delay sensitive PDU set;
an RLC data PDU that contains an RLC SDU or an RLC SDU segment belonging to a delay sensitive PDU set and is pending for initial transmission or retransmission;
a delay sensitive RLC SDU or RLC SDU segment that has not yet been included in an RLC data PDU; or
an RLC data PDU that contains a delay sensitive RLC SDU or RLC SDU segment and is pending for initial transmission or retransmission.

In some embodiments, the lower layer includes an RLC layer.

In some embodiments, the delay sensitive PDCP SDU includes a PDCP SDU with a remaining time to expiry of a discard timer less than a second threshold.

In some embodiments, the delay sensitive PDU set is a set to which the delay sensitive PDCP SDU belongs.

In some embodiments, the delay sensitive RLC SDU includes an RLC SDU with a remaining time to expiry of the discard timer less than a third threshold.

In some embodiments, the delay sensitive PDU set is a set to which the delay sensitive RLC SDU belongs.

In some embodiments, the uplink buffer data do not include second data that have been successfully transmitted but are still in the buffer.

In some embodiments, the second data include at least one of the following:

a PDCP SDU, a PDCP Data PDU, an RLC SDU, an RLC SDU segment, or an RLC data PDU.

In some embodiments, the uplink buffer data do not include the following data that: the terminal equipment receives RLC acknowledgement for the data, and a discard timer associated with the data has not expired; or the terminal equipment receives RLC acknowledgement for the data, and successful transmission of the data has not been acknowledged by a PDCP status report.

In some embodiments, each of the logical channel groups configures a first threshold.

In some embodiments, the second threshold is identical to the first threshold.

In some embodiments, the third threshold is identical to the first threshold.

In some embodiments, the minimum remaining time is explicitly included in the DSR.

In some embodiments, the DSR is triggered by an MAC entity of the terminal equipment.

In some embodiments, the remaining time includes a remaining time to the expiry of the discard timer or a remaining value of the discard timer.

It should be noted that FIG. 3 only schematically illustrates the embodiment of this disclosure; however, this disclosure is not limited thereto. For example, an order of execution of the operations may be appropriately adjusted, and furthermore, some other operations may be added, or some operations therein may be reduced, and objects of the above operations may also be adjusted. And appropriate variants may be made by those skilled in the art according to the above contents, without being limited to what is contained in FIG. 3.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, the network device receives the delay status report, wherein the delay status report corresponds to the logical channel groups, and the minimum remaining time of the uplink buffer data in the logical channel groups is lower than the first threshold, which is advantageous to radio resource saving and transmit power of the terminal equipment.

### Embodiment of a Third Aspect

In the Media Access Control (MAC) specification of 3GPP, a buffer status report (BSR) MAC CE includes a buffer capacity (or buffer size) field. The buffer size field is an index of an integer value used to indicate a buffer size of a logical channel group (LCG) within a specific range.

For example, the buffer size field in the BSR MAC CE indicates that the buffer size in the specific range may be determined according to a buffer size table (also referred to as a buffer status table (BS table), also referred to as a buffer status report table (BSR table), etc.).

A legacy BS table is generated by using an exponential formula, wherein the larger an index, the larger a value and range of a buffer size (buffer status) to which the index corresponds. A size of the range of the buffer size to which the index corresponds is, for example, a difference between a maximum value and a minimum value of the buffer size to which the index corresponds. Therefore, the higher the index, the larger a quantization error.

For example, video images are often transmitted in XR services, an amount of data of the video images are very large, and the video images need to be transmitted quickly. Therefore, an index used by the UE in performing XR services is highly likely to correspond to a relatively large range. When the network device determines sizes of uplink resources that need to be allocated according to the range, it may allocate uplink resources according to an upper limit of the range indicated by the buffer size field, hence, uplink resources more than those actually demanded by the UE may possibly be allocated, thereby resulting in increase of delay, reduced capacity and more interference, and affecting power consumption of the UE.

Currently, it has been agreed in 3GPP to introduce a new BS table (also referred to as a newly-defined BS table) to avoid relatively large quantization errors.

It was found by the inventors that if an amount of data to be transmitted in (for) an LCG is within a range of the newly-defined BS table, the UE uses the newly-defined BS table; otherwise, the UE uses the legacy BS table. However, as an MAC PDU (media access control protocol data unit) carrying the BSR MAC CE may possibly include a part of data in the LCG, following situations may possibly exist that: the amount of data to be transmitted in the LCG is within the range of the newly-defined BS table before the BSR MAC CE is generated (i.e. before the MAC PDU is built); and after the MAC PDU is built, the amount of data in the LCG is out of the range of the newly-defined BS table. In such situations, the UE is unsure which BS table is to be used.

In order to solve the above problems, this disclosure provides an information processing method, applicable to a terminal equipment.

FIG. 4 is a schematic diagram of the information processing method of the embodiment of this disclosure. As shown in FIG. 4, the information processing method includes:
401: determining that the amount of data to be transmitted in the logical channel group is within a range of a first buffer size table, and the amount of data to be transmitted in the logical channel group after the MAC PDU is built is out of the range of the first buffer size table; and
402: generating a first BSR MAC CE, the first BSR MAC CE including first information, the first information indicating using either the first buffer size table or a second buffer size table.

According to the above embodiment, in the case where the amount of data to be transmitted in the LCG is within the range of the first buffer size table (i.e. within a buffer range specified in the first buffer size table) and the amount of data to be transmitted in the LCG after the MAC PDU is built is out of the range of the first buffer size table (i.e. out of the buffer range specified in the first buffer size table), the UE generates the first BSR MAC CE, the first BSR MAC CE including a piece of first information indicating using either the first buffer size table or the second buffer size table. Therefore, in the above situations, it is also possible to clarify a used buffer size table, which is helpful for the network device and the UE to have consistent understandings of the buffer status of the UE, and is helpful for the network device to allocate appropriate uplink resources for uplink data transmission of the UE, thereby saving radio resources.

For ease of description, the first BSR MAC CE and a second BSR MAC CE described later are collectively referred to as BSR MAC CEs, and the first buffer size table and the second buffer size table are collectively referred to as buffer size tables.

In some embodiments, in 401, the data to be transmitted in the LCG may be the uplink buffer data described in the embodiment of the first aspect of this disclosure. For example, the data to be transmitted may include the first data in the buffer that have not been successfully transmitted, or the data to be transmitted may not include the second data that have been successfully transmitted but are still in the buffer. However, this disclosure is not limited thereto, and the data to be transmitted in the LCG may include the first data and the second data, or may have other meanings.

Tables 1 and 2 are respective schematic representations of the first buffer size table and the second buffer size table in the embodiment of this disclosure. In some embodiments, as shown in Tables 1 and 2, the first buffer size table and the second buffer size table may include indices

$${Index}_{j} , {Index}_{j}^{′}$$

and ranges

$${A}_{i} ∼ {B}_{j} , {A}_{j}^{′} ∼ {B}_{j}^{′}$$

of the buffer sizes to the indices correspond; where, the ranges of the buffer sizes are in units of bytes, j is greater than or equal to 0 and less than or equal to N (N may be equal to 255), A₀ and/or B₀ and/or

$${A}_{0}^{′}$$

and/or

$${B}_{0}^{′}$$

is/are an integer/integers greater than or equal to 0, and A_{N} and B_{N} may also possibly be reserved values.

TABLE 1
First buffer size table

| Indices | Ranges of buffer sizes |
|---|---|
| Index₀ | A₀~B₀ |
| . . . | . . . |
| Indexⱼ | Aⱼ~Bⱼ |
| . . . | . . . |
| Index_{N} | A_{N}~B_{N} |

TABLE 2
Second buffer size table

| Indices | Ranges of buffer sizes |
|---|---|
| ${Index}_{0}^{′}$ | ${A}_{0}^{′} \sim {B}_{0}^{′}$ |
| ... | ... |
| ${Index}_{j}^{′}$ | ${{A}_{j}^{′} {B}_{j}^{′}}_{\sim}$ |
| ... | ... |
| ${Index}_{N}^{′}$ | ${A}_{N}^{′} \sim {B}_{N}^{′}$ |

Following is an example of table 2:

| Index | BS value |
|---|---|
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

The first buffer size table is, for example, the newly-defined BS table described above, and the second buffer size table is, for example, the legacy BS table described above or an existing BS table, wherein the ranges of the buffer sizes defined in the first buffer size table may be further division of a part of the ranges of the buffer sizes defined in the second buffer size table. Hence, when the first buffer size table is used, quantization errors may be reduced.

For example, in the second buffer size table, when the index

$${Index}_{n}^{′}$$

is greater than a first preset threshold, a size

$$( {B}_{n}^{′} - {A}_{n}^{′} )$$

of a range

$${A}_{n}^{′} ∼ {B}_{n}^{′}$$

of a buffer size to which the index corresponds is greater than a second preset threshold; where, n is an integer between 0 and N. In order to avoid relatively large quantization errors, the ranges

$${A}_{n}^{′} ∼ {B}_{N}^{′}$$

of the buffer sizes may be more finely divided by using the first buffer size table. For example, in the second buffer size table, the ranges

$${A}_{n}^{′} ∼ {B}_{N}^{′}$$

of the buffer sizes are divided into N-n intervals, and in the first buffer size table, the ranges

$${A}_{n}^{′} ∼ {B}_{N}^{′}$$

of the buffer sizes may be divided into N intervals; where,

$${A}_{0} = {A}_{n}^{′} ,$$

$$and$$

$${B}_{N} = {B}_{N}^{′} .$$

For another example, a maximum buffer size value of the second buffer size table is determined based on a maximum bit rate and a minimum frame rate of uplink XR services, and a minimum buffer size value thereof is determined based on a minimum bit rate and a maximum frame rate of the uplink XR services, which are divided into N value ranges by using exponential formulae. However, this disclosure is not limited thereto, and other ranges in the second buffer size table may be more finely divided by using the first buffer size table.

In some embodiments, the first BSR MAC CE may be a BSR MAC CE in a new format. Table 3 is a schematic diagram of the first BSR MAC CE in the embodiment of this disclosure. In some embodiments, as shown in Table 3, the first BSR MAC CE may include first information BTi indicating using either the first buffer size table or the second buffer size table; where, i is an integer greater than or equal to 0 and less than or equal to 7.

The first information BTi may be 1 bit, for example, setting the BTi field to be 1 indicates that LCGi uses the first buffer size table, and setting the BTi field to be 0 indicates that LCGi uses the second buffer size table; however, this disclosure is not limited thereto, and the first information may also be represented in other means.

That LCGi uses either the first buffer size table or the second buffer size table refers to, for example, that an amount of data to be transmitted in LCGi is encoded by using the first buffer size table or the second buffer size table. That is, the first information BTi is used to indicate that an amount of data to be transmitted of a corresponding LCGi is encoded by using either the first buffer size table or the second buffer size table.

TABLE 3
First BSR MAC CE

| | | | | | | | |
|---|---|---|---|---|---|---|---|
| LCG₇ | LCG₆ | LCG₅ | LCG₄ | LCG₃ | LCG₂ | LCG₁ | LCG₀ |
| BT₇ | BT₆ | BT₅ | BT₄ | BT₃ | BT₂ | BT₁ | BT₀ |

Buffer Size 1
Buffer Size 2
. . .
Buffer Size m

For example, as shown in Table 3, the first BSR MAC CE may further include a buffer size field, which is used to identify an amount of data to be transmitted of a corresponding LCG after the MAC PDU is built.

In a case where LCGi uses the second buffer size table, for example, in a case where the amount of data to be transmitted of the LCGi is not within the buffer range specified in the first buffer size table, the amount of data to be transmitted of the LCGi after the MAC PDU is built is within the range of the second buffer size table. In this case, a value of the buffer size field to which LCGi corresponds may be indicated or encoded by using the second buffer size table.

For example, after the MAC PDU is built, the amount of data to be transmitted of LCGi is within the range

$${A}_{j}^{′} ∼ {B}_{j}^{′}$$

of the second buffer size table. In this case, the value of the buffer size field to which LCGi corresponds may be an index

$${Index}_{j}^{′}$$

in the second buffer size table corresponding to the range

$${A}_{j}^{′} ∼ {B}_{j}^{′} .$$

In a case where LCGi uses the first buffer size table, for example, in a case where the amount of data to be transmitted of LCGi is within the buffer range specified in the first buffer size table, the amount of data to be transmitted of LCGi remains within the range of the first buffer size table after the MAC PDU is built. In this case, the value of the buffer size field to which LCGi corresponds may be indicated or encoded by using the first buffer size table.

For example, after the MAC PDU is built, the amount of data to be transmitted of LCGi is within the range Aⱼ~Bⱼ of the first buffer size table. In this case, the value of the buffer size field to which LCGi corresponds may be an index Indexⱼ in the first buffer size table corresponding to the range Aⱼ~Bⱼ.

In some embodiments, as shown in Table 3, the first BSR MAC CE may include an LCGi field, which represents whether a “buffer size” field of LCGi is present, that is, whether a “buffer size” corresponding to LCGi is included in the first BSR MAC CE. In Table 3, m is a positive integer less than or equal to 8.

In some embodiments, in a case where the amount of data to be transmitted in the logical channel group is within the range of the first buffer size table and the amount of data to be transmitted in the LCG after the MAC PDU is built is out of the range of the first buffer size table (i.e. not within the buffer range specified in the first buffer size table), the first information may indicate using the second buffer size table.

The first BSR MAC CE identifies, via second information (i.e. a buffer size field), an amount of data to be transmitted in a corresponding LCG after the MAC PDU is built, wherein after the MAC PDU is built, the amount of data to be transmitted in the corresponding LCG is within the range of the second buffer size table, that is, the value of the second information is indicated by using the second buffer size table.

For example, the value of the second information may be an index in the second buffer size table, wherein the amount of data to be transmitted in the corresponding LCG after the MAC PDU is built is within a range of a buffer size indicated by the index.

For example, the first information BTi in the first BSR MAC CE may be described in a form shown in Table 4.

TABLE 4
Explanation of BTi in the first BSR MAC CE

| | |
|---|---|
| - | BTᵢ:this field indicates which buffer size table is used to encode the buffer size of the logical |
| | channel group i after the MAC PDU has been built. The BTᵢ field set to 1 indicates that the |
| | buffer size table specified in Table 6.1.3.1a-x is used for the logical channel group i. The BTᵢ |
| | field set to 0 indicates that the buffer size table specified in Table 6.1.3.1-2 is used for the |
| | logical channel group i; |

For example, the second information Buffer Size in the first BSR MAC CE may be described in a form shown in Table 5.

TABLE 5
Explanation of Buffer Size in the first BSR MAC CE

| | |
|---|---|
| - | Buffer Size: The Buffer Size field identifies the total amount of data available according to |
| | the data volume calculation procedure in TS 38.322 [3] and TS 38.323 [4] across all logical |
| | channels of a logical channel group after the MAC PDU has been built (i.e. after the logical |
| | channel prioritization procedure, which may result the value of the Buffer Size field to |
| | zero). The size of the RLC headers and MAC subheaders are not considered in the buffer |
| | size computation. If the amount of data for an LCG is within the closed range of the buffer |
| | sizes specificed in Table 6.1.3.1a-x, the MAC entity shall use the BSR table specified in Table |
| | 6.1.3.1a-x to set the value of this field. Otherwise, the MAC entity shall use the BSR table |
| | specified in Table 6.1.3.1-2. The amount of data in this field is indicated in number of bytes. |
| | The length of this field is 8 bits. The Buffer Size fields are included in ascending order based |
| | on the LCGᵢ. |

In some embodiments, in the case where the amount of data to be transmitted in the logical channel group (LCG) is within the range of the first buffer size table and the amount of data to be transmitted in the LCG after the MAC PDU is built is out of the range of the first buffer size table (i.e. not within the buffer range specified in the first buffer size table), the first information may indicate using the first buffer size table.

The first BSR MAC CE identifies, via third information (i.e. a buffer size field), the amount of data to be transmitted in the corresponding LCG after the MAC PDU is built, wherein the amount of data to be transmitted in the corresponding LCG after the MAC PDU is built is within the range of the first buffer size table. A value of this third information is indicated by using the first buffer size table.

For example, the value of the third information may be a minimum value of an index of the first buffer size table. After the MAC PDU is built, the amount of data to be transmitted in the corresponding LCG corresponds to the minimum value of the index of the first buffer size table, that is, the amount of data to be transmitted in the corresponding LCG after the MAC PDU is built is within a range of a buffer size indicated by a minimum index of the first buffer size table.

For example, the third information Buffer Size in the first BSR MAC CE may be described in a form shown in Table 6.

TABLE 6
Explanation of Buffer Size in the first BSR MAC CE

| | |
|---|---|
| - | Buffer Size: The Buffer Size field identifies the total amount of data available according to |
| | the data volume calculation procedure in TS 38.322 [3] and TS 38.323 [4] across all logical |
| | channels of a logical channel group after the MAC PDU has been built (i.e. after the |
| | logical channel prioritization procedure, which may result the value of the Buffer Size |
| | field to [symbol] be the minimum BS value in Table 6.1.3.1a-x if the amount of data available |
| | is lower than or equal to the minimum BS value in Table 6.1.3.1a-x). The amount of data |
| | is indicated in number of bytes. The size of the RLC headers and MAC subheaders are not |
| | considered in the buffer size computation. The length of this field is 8 bits. The values for |
| | the Buffer Size fields are shown in Table 6.1.3.1a-x. The Buffer Size fields are included in |
| | ascending order based on the LCGᵢ. |

In some embodiments, as shown in FIG. 4, the information processing method further includes:
403: determining that an amount of data to be transmitted of at least one LCG is within the range of the first buffer size table and amounts of data to be transmitted of all LCGs after the MAC PDU is built is out of the range of the first buffer size table; and
404: generating a second BSR MAC CE.

In some embodiments, the second BSR MAC CE may be the legacy BSR MAC CE described above. Table 7 is a schematic diagram of the second BSR MAC CE of the embodiment of this disclosure. In some embodiments, as shown in Table 7, the second BSR MAC CE may not include the first information indicating using either the first buffer size table or the second buffer size table. For example, in a case of generating the second BSR MAC CE, the second buffer size table is used by default.

Therefore, in the case where the amount of data to be transmitted of at least one LCG is within the range of the first buffer size table and the amount of data to be transmitted of all LCGs after the MAC PDU is built is out of the range of the first buffer size table, generating a second BSR MAC CE with a smaller amount of data may reduce uplink overhead and save uplink resources.

TABLE 7
The second BSR MAC CE

| | | | | | | | |
|---|---|---|---|---|---|---|---|
| LCG₇ | LCG₆ | LCG₅ | LCG₄ | LCG₃ | LCG₂ | LCG₁ | LCG₀ |

Buffer Size 1
Buffer Size 2
. . .
Buffer Size m

That the second buffer size table is used by default may refer to that the amount of data to be transmitted of the corresponding LCG is encoded by using one of the second buffer size tables by default.

For example, as shown in Table 7, the second BSR MAC CE may include fourth information (i.e. a buffer size field), which is used to identify the amount of data to be transmitted in the corresponding LCG after the MAC PDU is built. After the MAC PDU is built, the amount of data to be transmitted in the LCG is within the range of the second buffer size table, that is, a value of the fourth information may be indicated or encoded by using the second buffer size table.

For example, the value of the fourth information may be an index in the second buffer size table, wherein the amount of data to be transmitted in the corresponding LCG after the MAC PDU is built is within a range of a buffer size indicated by the index.

However, this disclosure is not limited thereto, and in the case where the amount of data to be transmitted in at least one LCG is within the range of the first buffer size table and amounts of data to be transmitted of all LCGs after the MAC PDU is built are out of the range of the first buffer size table, the first BSR MAC CE may also be generated.

Buffer sizes to which the LCGs correspond may all correspond to the second buffer size table, or, buffer sizes to which the LCGs correspond may all correspond to the first buffer size table, and the buffer sizes to which the LCGs correspond are minimum values of the indices of the first buffer size table, in other words, after the MAC PDU is built, the amounts of data to be transmitted of the LCGs corresponds to the minimum values of the indices of the first buffer size table.

In some embodiments, the above LCG is configured to be allowed to use the newly-defined BS table.

In some embodiments, the conditions for the UE to generate the first BSR MAC CE (or the second BSR MAC CE) further include that uplink shared channel (UL-SCH) resources after logical channel prioritization may accommodate the first BSR MAC CE plus its subheaders; however, this disclosure is not limited thereto, and other conditions may also be included.

It should be noted that FIG. 4 only schematically illustrates the embodiment of this disclosure; however, this disclosure is not limited thereto. For example, an order of execution of the operations may be appropriately adjusted, and furthermore, some other operations may be added, or some operations therein may be reduced, and objects of the above operations may also be adjusted. And appropriate variants may be made by those skilled in the art according to the above contents, without being limited to what is contained in FIG. 4.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where the amount of data to be transmitted in the LCG is within the range of the first buffer size table and the amount of data to be transmitted in the LCG after the MAC PDU is built is out of the range of the first buffer size table, the UE generates the first BSR MAC CE, which includes first information indicating using either the first buffer size table or the second buffer size table. Therefore, in the above situations, it is also possible to clarify a used buffer size table, which is helpful for the network device and the UE to have consistent understandings of the buffer status of the UE, and is helpful for the network device to allocate appropriate uplink resources for uplink data transmission of the UE, thereby saving radio resources.

### Embodiment of a Fourth Aspect

The embodiment of this disclosure provides an information processing method, applicable to a network device. Reference may be made to the embodiment of the third aspect for contents identical to those in the embodiment of the third aspect, which shall not be repeated herein any further.

FIG. 5 is a schematic diagram of the information processing method of the embodiment of this disclosure, applicable to a network device. As shown in FIG. 5, the method includes:
501: receiving a first BSR MAC CE, the first BSR MAC CE including first information, the first information indicating using either a first buffer size table or a second buffer size table, wherein the first BSR MAC CE corresponds to an LCG, an amount of data to be transmitted in the LCG being within a range of the first buffer size table, and after an MAC PDU is built, the amount of data to be transmitted in the LCG being out of the range of the first buffer size table (i.e. not within the buffer range specified in the first buffer size table).

In some embodiments, the first information is used to indicate that the amount of data to be transmitted in the LCG is encoded by using either the first buffer size table or the second buffer size table.

In some embodiments, the first information indicates using the second buffer size table.

The first BSR MAC CE further includes second information, the second information identifying the amount of data to be transmitted in the LCG after the MAC PDU is built, wherein the amount of data to be transmitted in the LCG after the MAC PDU is built is within the range of the second buffer size table.

A value of the second information is indicated by using the second buffer size table. After receiving the first BSR MAC CE, the network device determines an amount of data to be transmitted in a corresponding LCG according to the second information and the second buffer size table indicated by the first information.

In some embodiments, the first information indicates using the first buffer size table.

The first BSR MAC CE further includes third information, the third information identifying the amount of data to be transmitted in the LCG after the MAC PDU is built, wherein the amount of data to be transmitted in the LCG after the MAC PDU is built corresponds to a minimum value of indices of the first buffer size table.

A value of the third information is indicated by using the first buffer size table. After receiving the first BSR MAC CE, the network device determines an amount of data to be transmitted in a corresponding LCG according to the third information and the second buffer size table indicated by the first information.

In some embodiments, as shown in FIG. 5, the information processing method may further include:
502: receiving a second BSR MAC CE, the second BSR MAC CE corresponding to LCGs, wherein an amount of data to be transmitted in at least one LCG is within the range of the first buffer size table, and after the MAC PDU is built, amounts of data to be transmitted in all the LCGs are out of the range of the first buffer size table.

In some embodiments, the second BSR MAC CE does not include the first information.

In some embodiments, the second BSR MAC CE includes fourth information, the fourth information identifying the amount of data to be transmitted in the LCG after the MAC PDU is built, wherein the amount of data to be transmitted in the LCG after the MAC PDU is built is within the range of the second buffer size table.

It should be noted that FIG. 5 only schematically illustrates the embodiment of this disclosure; however, this disclosure is not limited thereto. For example, an order of execution of the operations may be appropriately adjusted, and furthermore, some other operations may be added, or some operations therein may be reduced, and objects of the above operations may also be adjusted. And appropriate variants may be made by those skilled in the art according to the above contents, without being limited to what is contained in FIG. 5.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where the amount of data to be transmitted in the LCG is within the range of the first buffer size table and the amount of data to be transmitted in the LCG after the MAC PDU is built is out of the range of the first buffer size table, it is possible to clarify a used buffer size table, which is helpful for the network device and the UE to have consistent understandings of the buffer status of the UE, and is helpful for the network device to allocate appropriate uplink resources for uplink data transmission of the UE, thereby saving radio resources.

### Embodiment of a Fifth Aspect

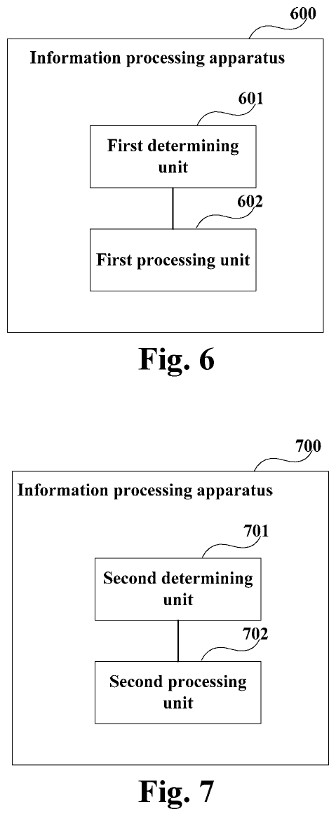

The embodiment of this disclosure provides an information processing apparatus, applicable to a terminal equipment. FIG. 6 is a schematic diagram of the information processing apparatus. The information processing apparatus is created based on a similar inventive concept as the information processing method in the embodiment of the first aspect of this disclosure, and their principles of solving problems are similar, hence, reference may be made to the implementation of the information processing method in the embodiment of the first aspect of this disclosure for implementation of the information processing apparatus, with repeated parts being not going to be described herein any further. The term “unit” or “module” used below refers to a combination of software and/or hardware that may achieve predetermined functions. Although the system described in the following embodiment is preferably implemented by software, implementation by hardware or a combination of software and hardware is also possible and envisioned.

As shown in FIG. 6, the information processing apparatus 600 includes:
a first determining unit 601 configured to determine that a minimum remaining time of uplink buffer data in logical channel groups (LCGs) is lower than a first threshold and there is no pending delay status report associated with the logical channel groups; and
a first processing unit 602 configured to trigger a delay status report for the logical channel groups.

In some embodiments, the uplink buffer data include first data in a buffer that have not been successfully transmitted.

In some embodiments, the first data include at least one of the following:
a PDCP SDU that has not yet been built to a PDCP data PDU;
a PDCP data PDU that has not yet been submitted to a lower layer;
a PDCP SDU to be retransmitted for a radio data bearer in an acknowledgement mode;
a PDCP data PDU to be retransmitted for a radio data bearer in the acknowledgement mode;
a PDCP SDU that belongs to a delay sensitive protocol data unit (PDU) set and has not yet been built to a PDCP data PDU;
a PDCP data PDU that contains a PDCP SDU belonging to the delay sensitive PDU set and has not yet been submitted to the lower layer;
a delay sensitive PDCP SDU that has not yet been built to a PDCP data PDU;
a PDCP data PDU that contains a delay sensitive PDCP SDU and has not yet been submitted to a lower layer;
an RLC SDU or an RLC SDU segment that has not yet been included in an RLC data PDU;
an RLC data PDU pending for initial transmission;
an RLC data PDU pending for retransmission;
an RLC SDU or an RLC SDU segment that has not yet been included in an RLC data PDU and belongs to the delay sensitive PDU set;
an RLC data PDU that contains an RLC SDU or an RLC SDU segment belonging to a delay sensitive PDU set and is pending for initial transmission or retransmission;
a delay sensitive RLC SDU or RLC SDU segment that has not yet been included in an RLC data PDU; and
an RLC data PDU that contains a delay sensitive RLC SDU or RLC SDU segment and is pending for initial transmission or retransmission.

In some embodiments, the lower layer includes an RLC layer.

In some embodiments, the delay sensitive PDCP SDU includes a PDCP SDU with a remaining time to expiry of a discard timer less than a second threshold.

In some embodiments, the delay sensitive PDU set is a set to which the delay sensitive PDCP SDU belongs.

In some embodiments, the delay sensitive RLC SDU includes an RLC SDU with a remaining time to expiry of the discard timer less than a third threshold.

In some embodiments, the delay sensitive PDU set is a set to which the delay sensitive RLC SDU belongs.

In some embodiments, the uplink buffer data do not include second data that have been successfully transmitted but are still in the buffer.

In some embodiments, the second data include at least one of the following: a PDCP SDU, a PDCP Data PDU, an RLC SDU, an RLC SDU segment, or an RLC data PDU.

In some embodiments, the uplink buffer data do not include the following data that: RLC acknowledgement for the data is received, and a discard timer associated with the data has not expired; or RLC acknowledgement for the data is received, and successful transmission of the data has not been acknowledged by a PDCP status report.

In some embodiments, each of the logical channel groups configures a first threshold.

In some embodiments, the second threshold is identical to the first threshold.

In some embodiments, the third threshold is identical to the first threshold.

In some embodiments, the minimum remaining time is explicitly included in the DSR.

In some embodiments, the DSR is triggered by an MAC entity of the terminal equipment.

In some embodiments, a PDCP entity and/or an RLC entity of the terminal equipment indicate(s) the remaining time of uplink buffer data to the MAC entity, and the MAC entity triggers the DSR according to the remaining time and the first threshold.

In some embodiments, the PDCP entity and/or the RLC entity of the terminal equipment further indicate(s) an amount of data of the uplink buffer data to the MAC entity.

It should be noted that the components or modules related to this disclosure are only described above. However, this disclosure is not limited thereto, and the information processing apparatus 600 may further include other components or modules, and reference may be made to related techniques for particulars of these components or modules.

Furthermore, for the sake of simplicity, connection relationships between the components or modules or signal profiles thereof are only illustrated in FIG. 6. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where the minimum remaining time of the uplink buffer data in the logical channel groups is lower than the first threshold and there is no pending delay status report associated with the logical channel groups, the terminal equipment triggers the delay status report for the logical channel groups. Hence, conditions for triggering the delay status report are clarified, which may reasonably trigger the delay status report, avoid unnecessarily triggering or transmitting the delay status report, and is advantageous to radio resource saving and transmit power of the terminal equipment.

The embodiment of this disclosure further provides an information processing apparatus, applicable to a terminal equipment. FIG. 7 is a schematic diagram of the information processing apparatus. The information processing apparatus is created based on a similar inventive concept as the information processing method in the embodiment of the third aspect of this disclosure, and their principles of solving problems are similar, hence, reference may be made to the implementation of the information processing method in the embodiment of the third aspect of this disclosure for implementation of the information processing apparatus, with repeated parts being not going to be described herein any further. The term “unit” or “module” used below refers to a combination of software and/or hardware that may achieve predetermined functions. Although the system described in the following embodiment is preferably implemented by software, implementation by hardware or a combination of software and hardware is also possible and envisioned.

As shown in FIG. 7, the information processing apparatus 700 includes:
a second determining unit 701 configured to determine that an amount of data to be transmitted in a logical channel group is within a range of a first buffer size table, and the amount of data to be transmitted in the logical channel group after an MAC PDU is built is out of the range of the first buffer size table (i.e. out of a buffer range specified by the first buffer size table); and
a second processing unit 702 configured to generate a first BSR MAC CE, the first BSR MAC CE including first information, the first information indicating using either the first buffer size table or a second buffer size table.

In some embodiments, the first information is used to indicate that the amount of data to be transmitted of the LCG is encoded by using either the first buffer size table or the second buffer size table.

In some embodiments, the first information indicates using the second buffer size table.

In some embodiments, the first BSR MAC CE further includes second information, the second information identifying an amount of data to be transmitted in a corresponding LCG after the MAC PDU is built.

In some embodiments, the amount of data to be transmitted in the corresponding LCG after the MAC PDU is built is within the range of the second buffer size table.

In some embodiments, a value of the second information is indicated by using the second buffer size table.

In some embodiments, the first information indicates using the first buffer size table.

In some embodiments, the first BSR MAC CE further includes third information, the third information identifying an amount of data to be transmitted in a corresponding LCG after the MAC PDU is built.

In some embodiments, the amount of data to be transmitted in the corresponding LCG after the MAC PDU is built corresponds to a minimum value of an index of the first buffer size table.

In some embodiments, a value of the third information is indicated by using the first buffer size table.

In some embodiments, the second determining unit 701 determines that an amount of data of at least one LCG is within the range of the first buffer size table and amounts of data of all LCGs are out of the range of the first buffer size table, and the second processing unit 702 generates a second BSR MAC CE.

In some embodiments, the second BSR MAC CE does not include the first information.

In some embodiments, the second BSR MAC CE includes fourth information, the fourth information identifying the amount of data to be transmitted in the LCG after the MAC PDU is built.

In some embodiments, the amount of data to be transmitted in the LCG after the MAC PDU is built is within the range of the second buffer size table.

It should be noted that the components or modules related to this disclosure are only described above. However, this disclosure is not limited thereto, and the information processing apparatus 700 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where the amount of data to be transmitted in the LCG is within the range of the first buffer size table and the amount of data to be transmitted in the LCG after the MAC PDU is built is out of the range of the first buffer size table, the UE generates the first BSR MAC CE, which includes first information indicating using either the first buffer size table or the second buffer size table. Therefore, in the above situations, it is also possible to clarify a used buffer size table, which is helpful for the network device and the UE to have consistent understandings of the buffer status of the UE, and is helpful for the network device to allocate appropriate uplink resources for uplink data transmission of the UE, thereby saving radio resources.

### Embodiment of a Sixth Aspect

The embodiment of this disclosure provides an information processing apparatus, applicable to a network device. FIG. 8 is a schematic diagram of the information processing apparatus. The information processing apparatus is created based on a similar inventive concept as the information processing method in the embodiment of the second aspect of this disclosure, and their principles of solving problems are similar, hence, reference may be made to the implementation of the information processing method in the embodiment of the second aspect of this disclosure for implementation of the information processing apparatus, with repeated parts being not going to be described herein any further. The term “unit” or “module” used below refers to a combination of software and/or hardware that may achieve predetermined functions. Although the system described in the following embodiment is preferably implemented by software, implementation by hardware or a combination of software and hardware is also possible and envisioned.

As shown in FIG. 8, the information processing apparatus 800 includes:
a first receiving unit 801 configured to receive a delay status report (DSR) transmitted by a terminal equipment, wherein the DSR corresponds to logical channel groups (LCGs), and a minimum remaining time of uplink buffer data in the LCGs is lower than a first threshold.

In some embodiments, there is no pending DSR associated with the LCGs before the DSR is triggered by the terminal equipment.

In some embodiments, after receiving the DSR, the network device allocates uplink resources to the terminal equipment according to the DSR.

In some embodiments, the uplink buffer data include first data in the uplink buffer that have not been successfully transmitted.

In some embodiments, the first data include at least one of a PDCP SDU, a PDCP data PDU, an RLC SDU, an RLC SDU segment, or an RLC data PDU.

In some embodiments, the uplink buffer data include at least one of the following: a PDCP SDU that has not yet been built to a PDCP data PDU;
a PDCP data PDU that has not yet been submitted to a lower layer;
a PDCP SDU to be retransmitted for a radio data bearer in an acknowledgement mode;
a PDCP data PDU to be retransmitted for a radio data bearer in the acknowledgement mode;
a PDCP SDU that belongs to a delay sensitive protocol data unit (PDU) set and has not yet been built to a PDCP data PDU;
a PDCP data PDU that contains a PDCP SDU belonging to the delay sensitive PDU set and has not yet been submitted to the lower layer;
a delay sensitive PDCP SDU that has not yet been built to a PDCP data PDU;
a PDCP data PDU that contains a delay sensitive PDCP SDU and has not yet been submitted to a lower layer;
an RLC SDU or an RLC SDU segment that has not yet been included in an RLC data PDU;
an RLC data PDU pending for initial transmission;
an RLC data PDU pending for retransmission;
an RLC SDU or an RLC SDU segment that has not yet been included in an RLC data PDU and belongs to the delay sensitive PDU set;
an RLC data PDU that contains an RLC SDU or an RLC SDU segment belonging to a delay sensitive PDU set and is pending for initial transmission or retransmission;
a delay sensitive RLC SDU or RLC SDU segment that has not yet been included in an RLC data PDU; or
an RLC data PDU that contains a delay sensitive RLC SDU or RLC SDU segment and is pending for initial transmission or retransmission.

In some embodiments, the lower layer includes an RLC layer.

In some embodiments, the delay sensitive PDCP SDU includes a PDCP SDU with a remaining time to expiry of a discard timer less than a second threshold.

In some embodiments, the delay sensitive PDU set is a set to which the delay sensitive PDCP SDU belongs.

In some embodiments, the delay sensitive RLC SDU includes an RLC SDU with a remaining time to expiry of the discard timer less than a third threshold.

In some embodiments, the delay sensitive PDU set is a set to which the delay sensitive RLC SDU belongs.

In some embodiments, the uplink buffer data do not include second data that have been successfully transmitted but are still in the buffer.

In some embodiments, the second data include at least one of the following: a PDCP SDU, a PDCP Data PDU, an RLC SDU, an RLC SDU segment, or an RLC data PDU.

In some embodiments, the uplink buffer data do not include the following data that: the terminal equipment receives RLC acknowledgement for the data, and a discard timer associated with the data has not expired; or the terminal equipment receives RLC acknowledgement for the data, and successful transmission of the data has not been acknowledged by a PDCP status report.

In some embodiments, each of the logical channel groups configures a first threshold.

In some embodiments, the second threshold is identical to the first threshold.

In some embodiments, the third threshold is identical to the first threshold.

In some embodiments, the minimum remaining time is explicitly included in the DSR.

In some embodiments, the DSR is triggered by an MAC entity of the terminal equipment.

In some embodiments, the remaining time includes a remaining time to the expiry of the discard timer or a remaining value of the discard timer.

It should be noted that the components or modules related to this disclosure are only described above. However, this disclosure is not limited thereto, and the information processing apparatus 800 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, the network device receives the delay status report, wherein the delay status report corresponds to the logical channel groups, and the minimum remaining time of the uplink buffer data in the logical channel groups is lower than the first threshold, which is advantageous to radio resource saving and transmit power of the terminal equipment.

The embodiment of this disclosure further provides an information processing apparatus, applicable to a network device. FIG. 9 is a schematic diagram of the information processing apparatus. The information processing apparatus is created based on a similar inventive concept as the information processing method in the embodiment of the fourth aspect of this disclosure, and their principles of solving problems are similar, hence, reference may be made to the implementation of the information processing method in the embodiment of the fourth aspect of this disclosure for implementation of the information processing apparatus, with repeated parts being not going to be described herein any further. The term “unit” or “module” used below refers to a combination of software and/or hardware that may achieve predetermined functions. Although the system described in the following embodiment is preferably implemented by software, implementation by hardware or a combination of software and hardware is also possible and envisioned.

As shown in FIG. 9, the information processing apparatus 900 includes:
a second receiving unit 901 configured to receive a first BSR MAC CE, the first BSR MAC CE including first information, the first information indicating using either a first buffer size table or a second buffer size table, wherein the first BSR MAC CE corresponds to an LCG, an amount of data to be transmitted in the LCG being within a range of the first buffer size table, and after an MAC PDU is built, the amount of data to be transmitted in the LCG being out of the range of the first buffer size table (i.e. not within the buffer range specified in the first buffer size table).

In some embodiments, the first information is used to indicate that the amount of data to be transmitted in the LCG is encoded by using either the first buffer size table or the second buffer size table.

In some embodiments, the first information indicates using the second buffer size table.

In some embodiments, in the case where the first information indicates using the second buffer size table, the first BSR MAC CE further includes second information, the second information identifying the amount of data to be transmitted in the LCG after the MAC PDU is built, wherein the amount of data to be transmitted in the LCG after the MAC PDU is built is within the range of the second buffer size table.

A value of the second information is indicated by using the second buffer size table. After receiving the first BSR MAC CE, the network device determines an amount of data to be transmitted in a corresponding LCG according to the second information and the second buffer size table indicated by the first information.

In some embodiments, the first information indicates using the first buffer size table.

In some embodiments, in the case where the first information indicates using the first buffer size table,
the first BSR MAC CE further includes third information, the third information identifying the amount of data to be transmitted in the LCG after the MAC PDU is built, wherein the amount of data to be transmitted in the LCG after the MAC PDU is built corresponds to a minimum value of indices of the first buffer size table.

A value of the third information is indicated by using the first buffer size table. After receiving the first BSR MAC CE, the network device determines an amount of data to be transmitted in a corresponding LCG according to the third information and the second buffer size table indicated by the first information.

In some embodiments, the second receiving unit 901 further receives a second BSR MAC CE, the second BSR MAC CE corresponding to LCGs, wherein an amount of data to be transmitted in at least one LCG is within the range of the first buffer size table, and after the MAC PDU is built, amounts of data to be transmitted in all the LCGs are out of the range of the first buffer size table.

In some embodiments, the second BSR MAC CE does not include the first information.

In some embodiments, the second BSR MAC CE includes fourth information, the fourth information identifying the amount of data to be transmitted in the LCG after the MAC PDU is built, wherein the amount of data to be transmitted in the LCG after the MAC PDU is built is within the range of the second buffer size table.

It should be noted that the components or modules related to this disclosure are only described above. However, this disclosure is not limited thereto, and the information processing apparatus 900 may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where the amount of data to be transmitted in the LCG is within the range of the first buffer size table and the amount of data to be transmitted in the LCG after the MAC PDU is built is out of the range of the first buffer size table, it is possible to clarify a used buffer size table, which is helpful for the network device and the UE to have consistent understandings of the buffer status of the UE, and is helpful for the network device to allocate appropriate uplink resources for uplink data transmission of the UE, thereby saving radio resources.

### Embodiment of a Seventh Aspect

The embodiment of this disclosure provides a communication system, and reference may be made to FIG. 1, with contents identical to those in the embodiments of the first to the sixth aspects being not going to be described herein any further.

In the embodiment of this disclosure, the terminal equipment 102 is configured to carry out the information processing method(s) as described in the embodiment(s) of the first and/or the third aspect(s), the contents of which being incorporated herein, and being not going to be described herein any further.

In the embodiment of this disclosure, the network device 101 is configured to carry out the information processing method(s) as described in the embodiment(s) of the second and/or the fourth aspect(s), the contents of which being incorporated herein, and being not going to be described herein any further.

The embodiment of this disclosure further provides a network device, which may be, for example, a base station. However, this disclosure is not limited thereto, and it may also be another network device.

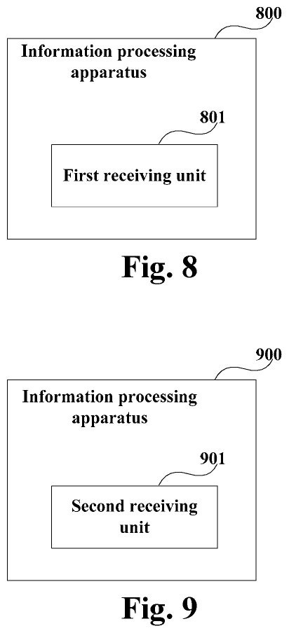

FIG. 10 is a schematic diagram of the network device of the embodiment of this disclosure. As shown in FIG. 10, the network device 1000 may include a processor 1001 (such as a central processing unit (CPU)) and a memory 1020, the memory 1020 being coupled to the processor 1001. Wherein, the memory 1020 may store various data, and furthermore, it may store a program for information processing, and execute the program under control of the processor 1001.

For example, the processor 1001 may be configured to execute a program to carry out the information processing method described in the embodiment of the second aspect. For example, the processor 1001 may be configured to execute the following control: receiving a delay status report (DSR) transmitted by a terminal equipment, wherein the DSR corresponds to logical channel groups (LCGs), and a minimum remaining time of uplink buffer data in the LCGs is lower than a first threshold.

For example, the processor 1001 may be configured to execute a program to carry out the information processing method described in the embodiment of the fourth aspect. For example, the processor 1001 may be configured to execute the following control: receiving a first BSR MAC CE, the first BSR MAC CE including first information, the first information indicating using either a first buffer size table or a second buffer size table, wherein the first BSR MAC CE corresponds to an LCG, an amount of data to be transmitted in the LCG being within a range of the first buffer size table, and after an MAC PDU is built, the amount of data to be transmitted in the LCG being out of the range of the first buffer size table.

Furthermore, as shown in FIG. 10, the network device 1000 may include a transceiver 1003, and an antenna 1004, etc., wherein functions of the above components are similar to those in the prior art, and shall not be described herein any further. It should be noted that the network device 1000 does not necessarily include all the parts shown in FIG. 10, and furthermore, the network device 1000 may include parts not shown in FIG. 10, and the prior art may be referred to.

The embodiment of this disclosure further provides a terminal equipment; however, this disclosure is not limited thereto, and it may also be another equipment.

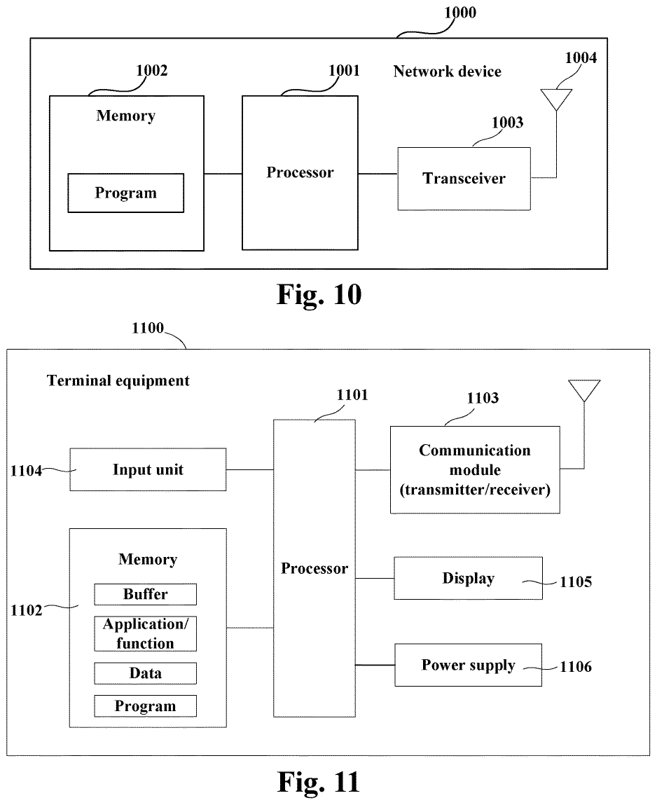

FIG. 11 is a schematic diagram of the terminal equipment of the embodiment of this disclosure. As shown in FIG. 11, the terminal equipment 1100 may include a processor 1101 and a memory 1102, the memory 1102 storing data and a program and being coupled to the processor 1101. It should be noted that this figure is illustrative only, and other types of structures may also be used, so as to supplement or replace this structure and achieve a telecommunications function or other functions.

For example, the processor 1101 may be configured to execute a program to carry out the information processing method described in the embodiment of the first aspect. For example, the processor 1101 may be configured to execute the following control: determining that a minimum remaining time of uplink buffer data in logical channel groups (LCGs) is lower than a first threshold and there is no pending delay status report (DSR) associated with the LCGs; and triggering a delay status report.

For example, the processor 1101 may be configured to execute a program to carry out the information processing method described in the embodiment of the third aspect. For example, the processor 1101 may be configured to execute the following control: determining that an amount of data to be transmitted in a logical channel group is within a range of a first buffer size table, and the amount of data to be transmitted in the logical channel group after the MAC PDU is built is out of the range of the first buffer size table; and generating a first BSR MAC CE, the first BSR MAC CE including first information, the first information indicating using either the first buffer size table or a second buffer size table.

As shown in FIG. 11, the terminal equipment 1100 may further include a communication module 1103, an input unit 1104, a display 1105, and a power supply 1106, wherein functions of the above components are similar to those in the prior art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the prior art may be referred to.

An embodiment of this disclosure provides a computer readable program code, which, when executed in a terminal equipment, will cause the terminal equipment to carry out the information processing method(s) as described in the embodiment(s) of the first aspect and/or the third aspect.

An embodiment of this disclosure provides a computer readable medium, including a computer readable program code, which will cause a terminal equipment to carry out the information processing method(s) as described in the embodiment(s) of the first aspect and/or the third aspect.

An embodiment of this disclosure provides a computer readable program code, which, when executed in a network device, will cause the network device to carry out the information processing method(s) as described in the embodiment(s) of the second aspect and/or the fourth aspect.

An embodiment of this disclosure provides a computer readable medium, including a computer readable program code, which will cause a network device to carry out the information processing method(s) as described in the embodiment(s) of the second aspect and/or the fourth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to implementations containing the above embodiments, following supplements are further disclosed.
1. An information processing apparatus, configured in a terminal equipment, the apparatus including:
a second determining unit configured to determine that an amount of data to be transmitted in a logical channel group is within a range of a first buffer size table, and the amount of data to be transmitted in the logical channel group after an MAC PDU is built is out of the range of the first buffer size table; and
a second processing unit configured to generate a first BSR MAC CE, the first BSR MAC CE including first information, the first information indicating using either the first buffer size table or a second buffer size table.
2. The apparatus according to supplement 1, wherein,
the first information is used to indicate that the amount of data to be transmitted of the LCG is encoded by using either the first buffer size table or the second buffer size table.
3. The apparatus according to supplement 1, wherein,
the first information indicates using the second buffer size table.
4. The apparatus according to supplement 1 or 3, wherein,
the first BSR MAC CE further includes second information, the second information identifying an amount of data to be transmitted in a corresponding LCG after the MAC PDU is built.
5. The apparatus according to supplement 4, wherein,
the amount of data to be transmitted in the corresponding LCG after the MAC PDU is built is within the range of the second buffer size table; and/or
a value of the second information is indicated by using the second buffer size table.
6. The apparatus according to supplement 1, wherein,
the first information indicates using the first buffer size table.
7. The apparatus according to supplement 1 or 6, wherein,
the first BSR MAC CE further includes third information, the third information identifying an amount of data to be transmitted in a corresponding LCG after the MAC PDU is built.
8. The apparatus according to supplement 7, wherein,
the amount of data to be transmitted in the corresponding LCG after the MAC PDU is built corresponds to a minimum value of an index of the first buffer size table; and/or
a value of the third information is indicated by using the first buffer size table.
9. The apparatus according to supplement 1, wherein,
the second determining unit determines that an amount of data of at least one LCG is within the range of the first buffer size table and amounts of data of all LCGs are out of the range of the first buffer size table,
and the second processing unit generates a second BSR MAC CE.
10. The apparatus according to supplement 9, wherein,
the second BSR MAC CE does not include the first information; and/or
the second BSR MAC CE includes fourth information, the fourth information identifying the amount of data to be transmitted in the LCG after the MAC PDU is built.

1. An information processing apparatus, configured in a terminal equipment, the apparatus comprising:
a second determining unit configured to determine an amount of data to be transmitted in a logical channel group (LCG), and that the amount of data to be transmitted in the LCG after a medium access control protocol data unit (MAC PDU) is built is out of a range of a first buffer size table; and
a second processing unit configured to generate a first buffer status report medium access control control element (BSR MAC CE), the first BSR MAC CE comprising first information, the first information indicating using a second buffer size table.

2. The apparatus according to claim 1, wherein,
the first BSR MAC CE further comprises second information, the second information identifying the amount of data to be transmitted in the LCG after the MAC PDU is built.

3. The apparatus according to claim 2, wherein,
a value of the second information is indicated by using the second buffer size table.

4. The apparatus according to claim 1, wherein,
the first information is used to indicate that the amount of data to be transmitted in the LCG is encoded by using either the first buffer size table or the second buffer size table.

5. The apparatus according to claim 1, wherein,
the second determining unit determines that an amount of data to be transmitted in at least one LCG is within the range of the first buffer size table and an amount of data to be transmitted in all LCGs after an MAC PDU is built is out of the range of the first buffer size table, and the second processing unit generates a second BSR MAC CE.

6. The apparatus according to claim 5, wherein,
the second BSR MAC CE does not comprise the first information; and/or
the second BSR MAC CE comprises fourth information, the fourth information identifying the amount of data to be transmitted in the LCG after the MAC PDU is built.

7. An information processing apparatus, configured in a terminal equipment, the apparatus comprising:
a first determining unit configured to determine that a minimum remaining time of uplink buffer data in a logical channel group (LCG) is lower than a first threshold and there is no pending delay status report associated with the LCG; and
a first processing unit configured to trigger a delay status report, wherein the uplink buffer data comprise first data in a buffer that have not been transmitted.

8. The apparatus according to claim 7, wherein the first data comprise at least one of the following:
a packet data convergence protocol service data unit (PDCP SDU), a packet data convergence protocol data protocol data unit (PDCP data PDU), a radio link control service data unit (RLC SDU), a radio link control service data unit segment (RLC SDU segment), or a radio link control data protocol data unit (RLC data PDU).

9. The apparatus according to claim 7, wherein the uplink buffer data comprise at least one of the following:
a PDCP SDU that has not yet been built to a PDCP data PDU;
a PDCP data PDU that has not yet been submitted to a lower layer;
a PDCP SDU to be retransmitted for a radio data bearer in an acknowledgement mode;
a PDCP data PDU to be retransmitted for a radio data bearer in an acknowledgement mode;
a PDCP SDU that belongs to a delay sensitive protocol data unit (PDU) set and has not yet been built to a PDCP data PDU;
a PDCP data PDU that contains a PDCP SDU belonging to a delay sensitive PDU set and has not yet been submitted to a lower layer;
a delay sensitive PDCP SDU that has not yet been built to a PDCP data PDU;
a PDCP data PDU that contains a delay sensitive PDCP SDU and has not yet been submitted to a lower layer;
an RLC SDU or an RLC SDU segment that has not yet been included in an RLC data PDU;
an RLC data PDU pending for initial transmission;
an RLC data PDU pending for retransmission;
an RLC SDU or an RLC SDU segment that has not yet been included in an RLC data PDU and belongs to a delay sensitive PDU set;
an RLC data PDU that contains an RLC SDU or an RLC SDU segment belonging to a delay sensitive PDU set and is pending for initial transmission or retransmission;
a delay sensitive RLC SDU or RLC SDU segment that has not yet been included in an RLC data PDU; or
an RLC data PDU that contains a delay sensitive RLC SDU or RLC SDU segment and is pending for initial transmission or retransmission.

10. The apparatus according to claim 7, wherein,
the uplink buffer data do not comprise second data that have been successfully transmitted but are still in the buffer.

11. The apparatus according to claim 10, wherein the second data comprise at least one of the following:
a PDCP SDU, a PDCP Data PDU, an RLC SDU, an RLC SDU segment, or an RLC data PDU.

12. The apparatus according to claim 7, wherein the uplink buffer data do not comprise the following data that:
RLC acknowledgement for the data is received, and a discard timer associated with the data has not expired; or
RLC acknowledgement for the data is received, and successful transmission of the data has not been acknowledged by a PDCP status report.

13. The apparatus according to claim 7, wherein,
the delay status report is triggered by a media access control (MAC) entity of the terminal equipment.

14. The apparatus according to claim 13, wherein,
a PDCP entity and/or an RLC entity of the terminal equipment indicate(s) a remaining time of uplink buffer data to the MAC entity, and the MAC entity triggers the delay status report according to the remaining time and the first threshold.

15. A communication system, comprising:
a terminal equipment configured to determine an amount of data to be transmitted in a logical channel group (LCG), and that the amount of data to be transmitted in the LCG after an MAC PDU is built is out of a range of a first buffer size table, and generate a first BSR MAC CE, the first BSR MAC CE comprising first information, the first information indicating using a second buffer size table.
